(19) United States
(12) Patent Application Publication
(10) Pub. No.: US 2019/0303879 A1
(43) Pub. Date: Oct. 3, 2019

(54) MEETING RECORDING SOFTWARE

(71) Applicant: CA, Inc., New York, NY (US)

(72) Inventors: Serge Mankovskii, Morgan Hill, CA (US); Maria C. Velez-Rojas, Santa Clara, CA (US)

(21) Appl. No.: 15/943,380

(22) Filed: Apr. 2, 2018

(51) Int. Cl. G06Q 10/10; H04L 12/18; G06F 17/30; G06F 3/16

(52) U.S. Cl. CPC G06Q 10/1095; H04L 12/1831; G06F 17/30191; G06F 3/167; G06F 17/30283

(57) ABSTRACT

Techniques are disclosed relating to a computer system detecting the start of a meeting between a plurality of individuals, initiating a recording of the particular meeting, receiving a recording confirmation command from one of the plurality of individuals, and based on receiving the recording confirmation command causing the recording of the particular meeting to be retained by the computer system for subsequent playback. The recording confirmation command may be received during the meeting as it is being recorded or after the meeting has ended. The computer system may store meeting metadata indicative of the recorded meeting. In some embodiments, the meeting metadata is stored in a blockchain-based shared ledger.

### BACKGROUND

### Technical Field

This disclosure relates generally to recording meetings between individuals and storing recordings for subsequent playback.

### Description of the Related Art

Depending on the size of the enterprise, the various employees and contractors of a company may engage in any of a number of meetings on a day-to-day basis. Recordings of one or more meetings may be made to, for example, document what was discussed at the meetings and whether any decisions were made. Some recordings of meetings may be stored securely and made available for subsequent review. But if a recording is not initiated for a meeting, information may be lost.

### SUMMARY

Techniques are disclosed herein to prevent information loss by recording meetings. In various embodiments, a computer system enables individuals attending a meeting to retroactively decide to retain a recording of the meeting for subsequent playback such that the recording includes portions of the meeting that occurred before the decision to retain the recording was made. In some embodiments, one or more of the individuals decide to retain a recording of the meeting while the meeting is ongoing. In other embodiments, one or more individuals decide to retain a recording of the meeting after the meeting has concluded. In these embodiments, the computer system records all of the meeting in case one of more individuals attending the meeting decide that a recording of the meeting should be retained for future playback. However, merely automatically recording the entirety of all meetings regardless of whether the individuals attending a given meeting have indicated their decision that a recording of the given meeting should be retained may (1) result in using resources to store recordings of meetings that are not interesting or important enough to warrant retention and (2) potentially have privacy or security implications because some individuals may object to being recorded or may decide that some topics discussed at the meeting should not be recorded (e.g., privileged communications between clients and attorneys). The techniques disclosed herein, though, relate to recording a meeting and, based on having received a recording confirmation command from one or more of the individuals, retaining a recording of the meeting for future playback without the individuals deciding at the outset of the meeting that a recording ought to be made.

### BRIEF DESCRIPTION OF THE DRAWINGS

FIG. 1 is a block diagram illustrating an embodiment of a computer system configured to record and store a recording of at least a portion of a meeting.

FIG. 2 is an expanded block diagram of the computer system of FIG. 1 in accordance with various embodiments.

FIGS. 3A, 3B, 3C, and 3D are diagrams showing various timelines in accordance with various embodiments.

FIG. 4 is a flowchart illustrating an embodiment of a meeting recording decision method in accordance with the disclosed embodiments.

FIG. 5 is flowchart illustrating an embodiment of an alternative meeting recording decision method in accordance with the disclosed embodiments.

FIG. 6 is a block diagram of an exemplary computer system, which may implement the various components of FIGS. 1 and 2.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computer system configured to initiate a recording” is intended to cover, for example, a computer system has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, references to “first” and “second” individuals would not imply an ordering between the two unless otherwise stated.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

As used herein, the word “module” refers to structure that stores or executes a set of operations. A module refers to hardware that implements the set of operations, or a memory storing the set of instructions such that, when executed by one or more processors of a computer system, cause the computer system to perform the set of operations. A module may thus include an application-specific integrated circuit implementing the instructions, a memory storing the instructions and one or more processors executing said instructions, or a combination of both.

### DETAILED DESCRIPTION

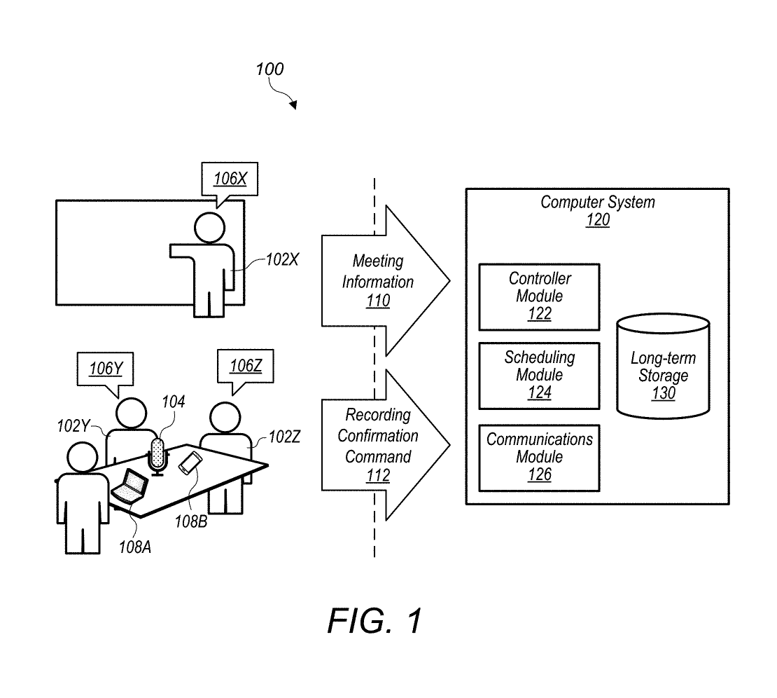

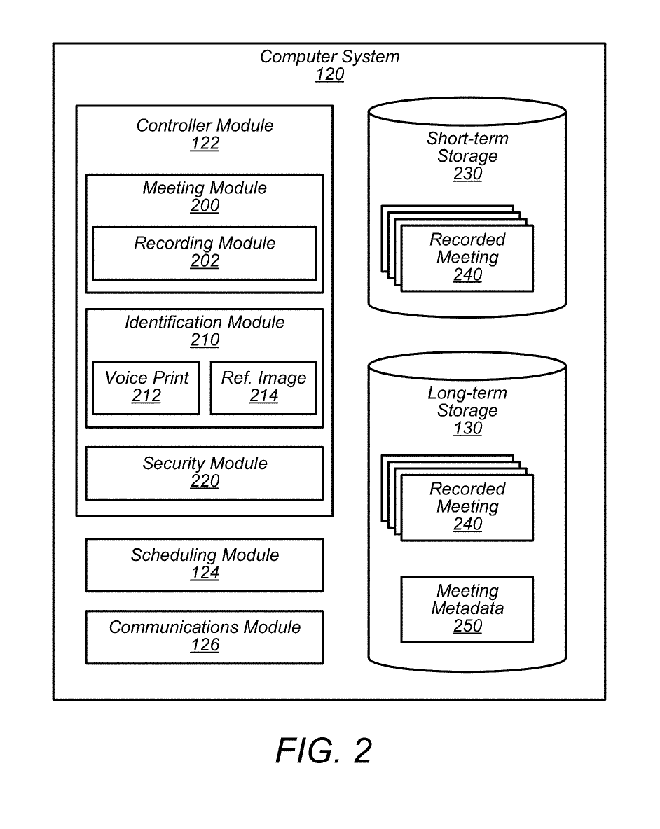

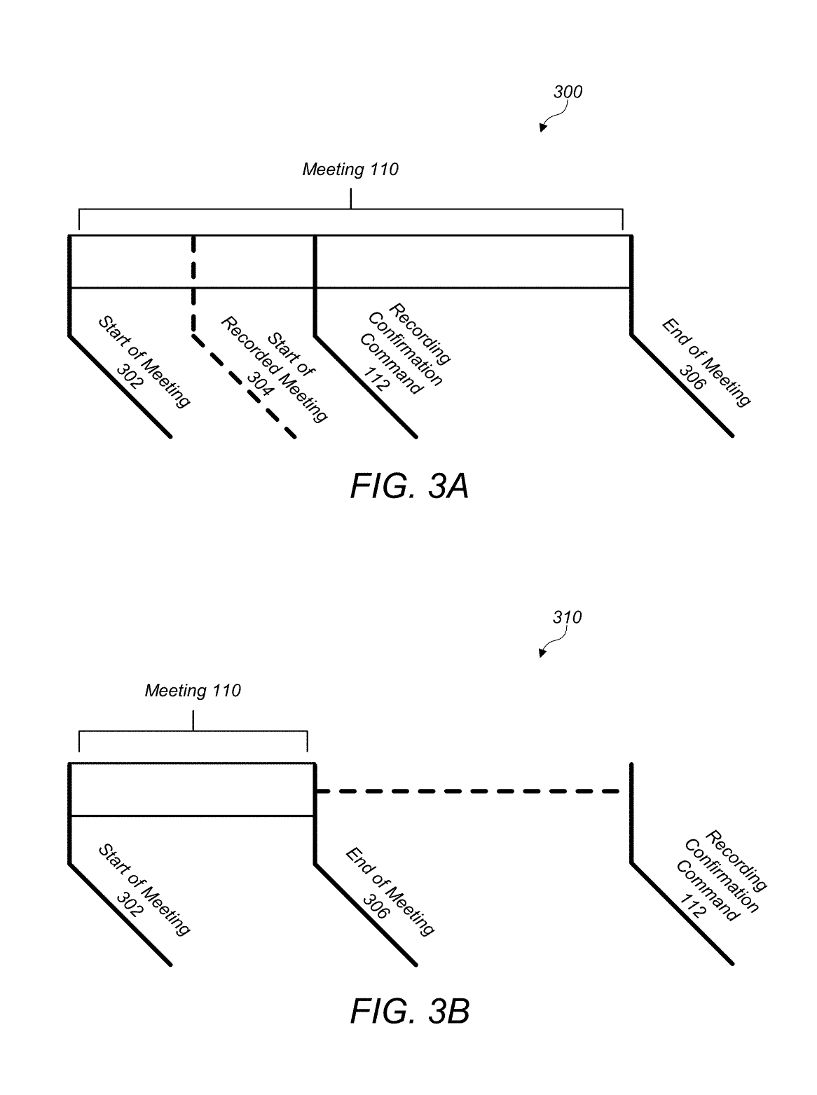

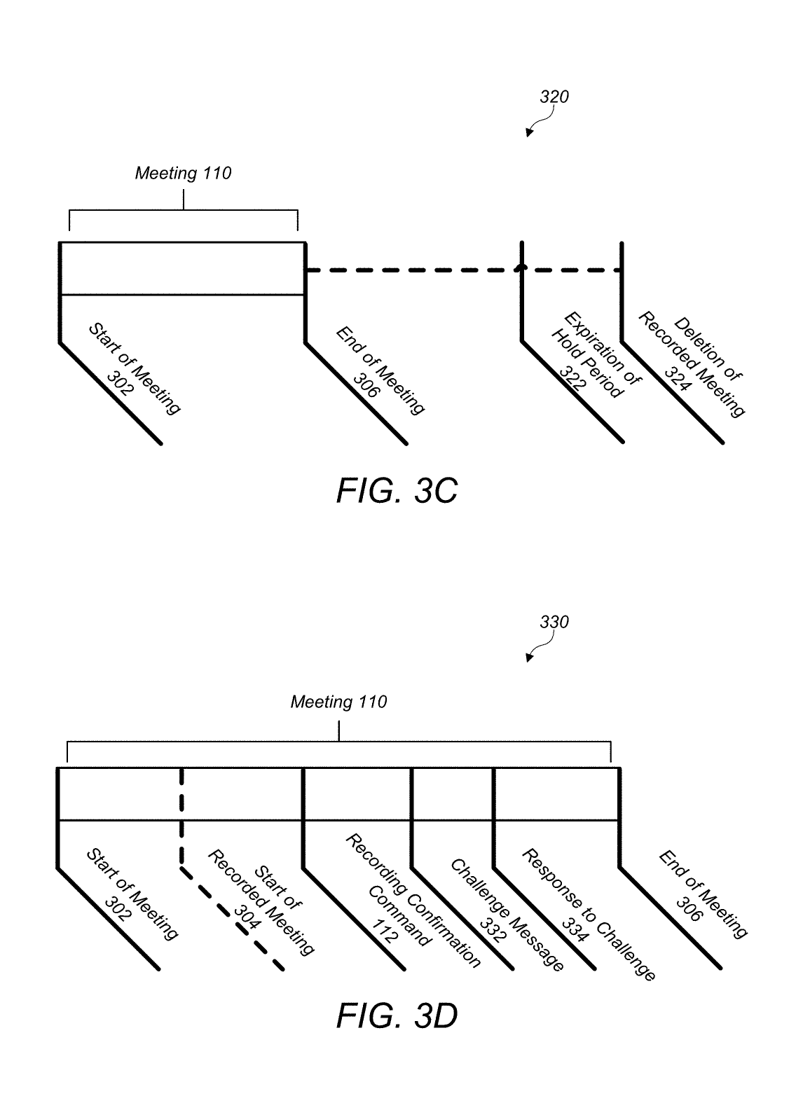

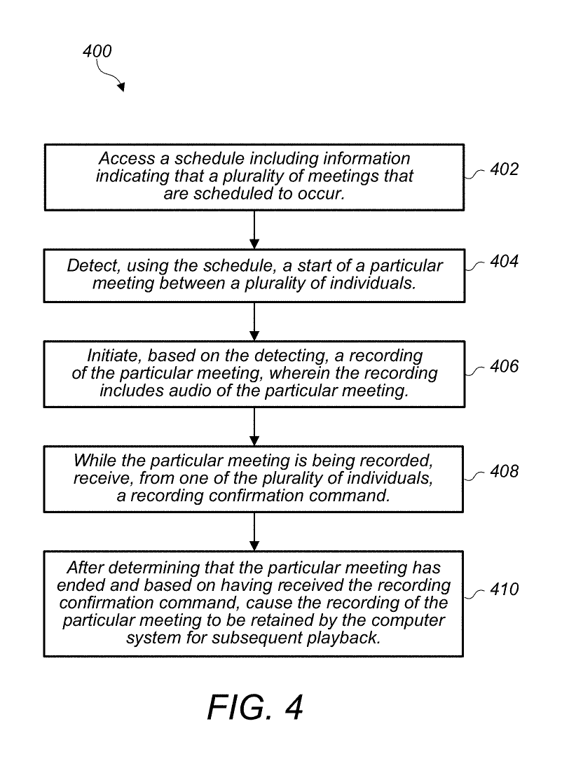

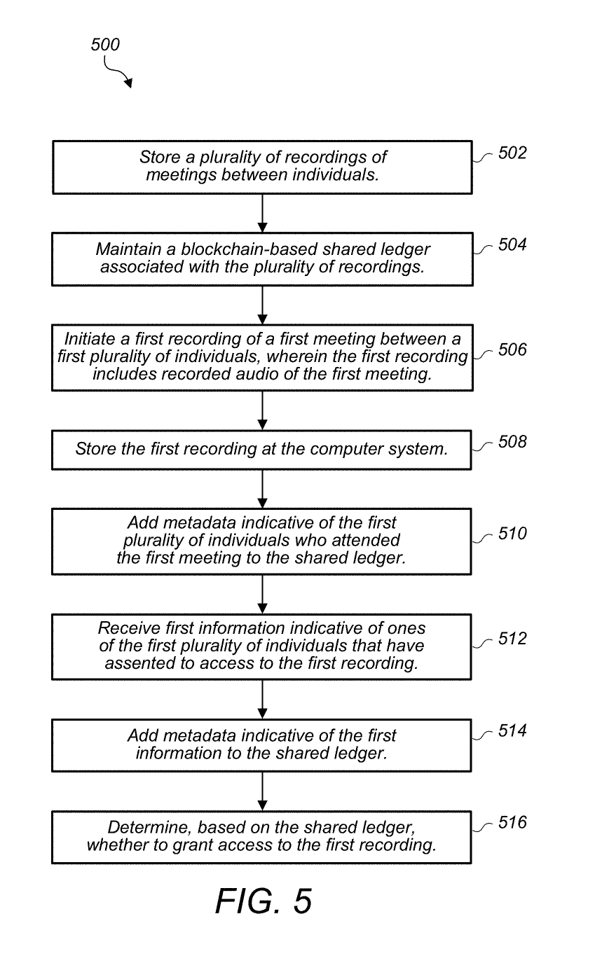

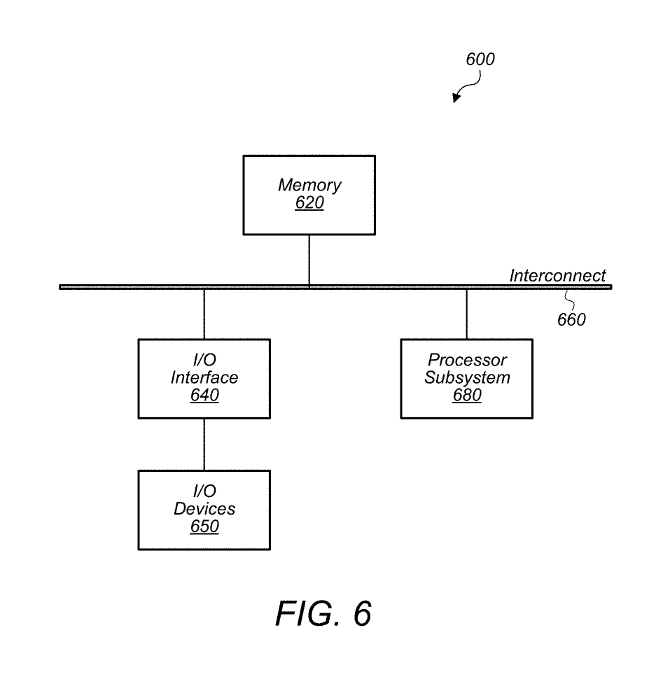

This disclosure describes techniques for recording a meeting and storing recordings for future playback. Embodiments for a meeting, a recording of the meeting, and the computer system on which the recording of the meeting is stored are described in reference to FIG. 1. Further details relating to the computer system are discussed with reference to FIG. 2. The chronology of various aspects of the disclosed embodiments are discussed with reference to FIGS. 3A, 3B, 3C, and 3D. Further details relating to the meeting recording decision method are described with reference to FIG. 4. Further details relating to the alternative meeting recording decision method are described with reference to FIG. 5. Finally, an exemplary computer system, which may implement the various components of FIGS. 1 and 2, is discussed with reference to FIG. 6.

Referring now to FIG. 1, a block diagram of an exemplary embodiment of a computer system 120 configured to record meeting 100 is depicted. During meeting 100, meeting information 110 and a recording confirmation command 112 are transmitted to computer system 120.

Meeting 100 occurs between a plurality of individuals 102. In various embodiments, meeting 100 may be an in-person meeting between individuals 102, a telephonic meeting between individuals 102, an online meeting between individuals 102 (e.g., occurring over VOIP, occurring over a video conferencing service such as Skype®, Google®, or Facebook®), or a combination. The plurality of individuals 102 may be physically in the same location (e.g., in a conference room), may be in different, remote locations (e.g., at the individuals' 102 various offices), or a combination where some individuals 102 are in the same location but others are remote (e.g., a group of individuals 102 are meeting in a conference room in California with other individuals calling into the meeting from Texas and British Columbia). Meeting 100, for example, may be an in-person meeting (e.g., taking place in an office, conference room, etc.) where an individual 102X is presenting information to other individuals including individuals 102Y and 102Z as shown in FIG. 1.

Individuals 102 are any of a number of people who are attending meeting 100 (either in-person or remotely). At meeting 100, the individuals 102 make a number of statements 106. In various embodiments, statement 106 is a vocalization by an individual 102 (e.g., spoken in an in-person meeting, spoken on in a telephonic meeting), but statement 106 may be any of a number of communications from an individual 102 including but not limited to vocalizations, written messages, sign language, electronic messages, etc. As part of attending meeting 100, individuals 102 (including individuals 102 physically present at meeting 100 and remotely-located individuals 102) may access meeting software (e.g., discussed herein in reference to meeting module 200 on FIG. 2) that presents video signals to the remotely-located individuals 102 and/or allows projection in a conference room, allows individuals 102 to project information on the screens of computing devices 108 associated with various other individuals 102 (e.g., by “sharing” their screen) to visually present information, and may be in communication with or a part of recording device 104 discussed herein.

In various embodiments, individuals 102, for example, may be employees and contractors working for the same enterprise. Among the plurality of individuals 102, there may be a number of key individuals 102. In various embodiments, who qualifies as a “key individual” may vary. In some embodiments, computer system 120 obtains information about the one or more enterprises associated with meeting 100 and designates, based on a hierarchy of the one or more individuals 102 attending meeting 100, the individuals 102 in the highest levels the entities (e.g., higher ranking employees, officers, directors, owners) as key individuals. In various embodiments, the schedule includes information indicating that the presence of certain individuals 102 is required at meeting 100, and these individuals 102 are designated as key individuals 102. In some embodiments, the organizer of meeting 100 is designated as a key individual 102. In some embodiments, the organizer of meeting 100 can manually designated one or more individuals 102 attending meeting 100 as key individuals 102.

In embodiments where the plurality of individuals 102 arrive at a decision at meeting 100, in some embodiments one or more of these key individuals 102 must agree to the decision for the decision to be implemented. For example, in a meeting 100 among a director of engineering and her direct reports discussing the design of a widget and whether to build a prototype, it may be the case that the director must agree to the design of the widget before the prototype is built. In the embodiment depicted in FIG. 1, five individuals 102 are attending meeting 100 including individual 102X who is giving a presentation, and individual 102Y and key individual 102Z. During meeting 100, the various individuals 102 make statements 106. As discussed herein, the decision whether to retain a recording of meeting 100 may be left to key individual 102Z in various embodiments.

Recording device 104 is any of a number of devices that are configured to record meeting 100. In various embodiments, recording device 104 includes a microphone and records the audio of meeting 100. In such embodiments, recording device 104 may comprise a dedicated recording device 104 or a general-purpose device such as a laptop or cellular phone used as a recording device 104. In various embodiments, recording device 104 relays signals based on the audio of the meeting to software (e.g., running on a computer, server, or plurality of servers) that packages the signals into a recording. In various embodiments, there may be a plurality of recording devices 104 that work together to create the recording of meeting 100 (e.g., by using multiple microphones that are mixed together in the recorded meeting 240 of meeting 100 retained for subsequent playback, by using multiple general-purpose devices running recording software whose signals are mixed together in the recorded meeting 240 of meeting 100 retained for subsequent playback). Recording device 104 may include a user interface configured to receive commands from individuals 102 that includes by is not limited to physical buttons, a touch screen and a graphical user interface, a pointing device, or a combination.

In addition to recording audio, in various embodiments recording device 104 may record images or video of meeting 100 (e.g., with one or more cameras filming ones of the individuals 102, one or more conference rooms in which meeting 100 is occurring, etc.) and may record images or video of material presented at meeting 100 (e.g., a recording the material an individual 102 is sharing from his or her computer, a presentation one or more individuals 102 is giving to other individuals 102 in meeting 100). In various embodiments, recording device 104 may also record indications of electronic files viewed, revised, or generated during the meeting (e.g., a spreadsheet, text document, presentation, etc.) using one or more computing devices 108. In such embodiments, these indications may include links to the electronic files (e.g., links to the document on a server or cloud of servers) or the electronic files themselves. In some embodiments where individuals 102 can make statements 106 (e.g., written statements to the general audience of meeting 100, private messages between individuals 102 attending meeting 100) through a chat feature in meeting software, recording device 104 may also record any or all statements 106 made using such a chat features. Accordingly, in various embodiments, recording device 104 includes one or more devices (e.g., microphones, cameras, computer screen capturing software) configured to record one or more of audio information associated with meeting 100, visual information associated with meeting 100, and electronic transmission information associated with meeting 100.

Computing devices 108 include one or more electronics devices configured to access and/or edit one of more files during meeting 100 in various embodiments. In various embodiments, computing devices 108 include personal computers 108A (e.g., a laptop computer, a tablet computer, a desktop computer) and/or mobile devices 108B (e.g., a smartphone, a wearable computer). In various embodiments, computing device 108 are associated with ones of the plurality of individuals 102 (e.g., an individual 102 is logged-in to a particular computing device 108, an individual 102 has been assigned a particular computing device 108).

Meeting information 110 includes the various information captured by the one or more recording devices 104 of at least a portion of meeting 100. In various embodiments, meeting information 110 includes audio information (e.g., vocally-spoken statements 106 from individuals 102). In some of such embodiments, meeting information 110 includes visual information (e.g., images, video, electronic messages, presentations given at meeting 100). In various embodiments, meeting information 110 includes information indicative of accesses and/or revisions to one of more files made by one of more of the individuals 102 using one of more computing device 108 during meeting 100. In various embodiments, meeting information 110 is encrypted (e.g., by recording device 104, computing device 108) before being sent to computer system 120.

Recording confirmation command 112 may be any message used by one of more individuals 102 to indicate the one of more individuals' 102 assent to retaining a recording of the meeting 100 for subsequent playback. Recording confirmation command 112 may be verbal, non-verbal (e.g., a gesture, a sign), visual, electronic, or a combination. In various embodiments, recording confirmation command 112 is captured by a microphone or camera (e.g., a microphone or camera of recording device 104). In other embodiments, recording confirmation command 112 is entered via a user interface (e.g., of a computing device 108 or recording device 104). As used herein, a particular individual's 102 “assent” to retain a recording is an indication that the particular individual 102 has approved retaining a recording of the meeting 100. Assent may be given (or denied) for retaining a recording of a particular meeting 100, may be given using generalized rules (e.g., individual 102Z generally assents to recording all meetings between herself and her direct reports), or may be given by a delegate (e.g., a person, software) appointed by individual 102. In various embodiments, recording confirmation command 112 is received during meeting 100. In other embodiments, recording confirmation command 112 is received after meeting 100 has ended. In various embodiments, recording confirmation command 112 is encrypted (e.g., by recording device 104, computing device 108) before being sent to computer system 120. Recording confirmation command 112 is discussed in further detail in reference to FIGS. 3A, 3B, and 3D herein.

In the embodiment depicted in FIG. 1, computer system 120 includes a controller module 122, a scheduling module 124, a communications module 126, and long-term storage 130. While only one of each of the controller module 122, scheduling module 124, communications module 126, and long-term storage 130 are shown in FIG. 1, it will be understood that in various embodiments, computer system 120 may include more than one of some of all of these components (e.g., two scheduling modules 124) and that the various components each may be implemented using hardware, software, or a combination of the two. Controller module 122, scheduling module 124, communications module 126, and long-term storage 130 are discussed in further detail in reference to FIG. 2 herein.

Computer system 120 is configured to receive meeting information 110 (e.g., with communications module 126) from one or more recording devices 104. Computer system 120 is further configured to receive recording confirmation command 112 (e.g., with communications module 126) from one or more recording device 104 and/or computing device 108. In various embodiments where meeting information 110 and/or recording confirmation command 112 are encrypted, computer system 120 is configured to decrypt the encrypted meeting information 110 and/or recording confirmation command 112. As discussed herein, computer system 120 is configured to store recorded meeting information 110 in long-term storage 130 (e.g., as recorded meetings 240 discussed herein). Computer system 120 is configured to access a schedule (e.g., with scheduling module 124) including information indicating a plurality of meetings 100 that are scheduled to occur and detect, using the schedule, the start of a particular meeting 100. Computer system 120 is configured to initiate a recording of the particular meeting 100, receive one or more recording confirmation commands 112 (e.g., with communications module 126) and, after determining that the particular meeting has ended and based on having received a recording confirmation command 112, cause the recording of the particular meeting 100 to be retained in long-term storage 130 for subsequent playback. In various embodiments, if a recording confirmation command 112 has not been received (e.g., received during the meeting 100, received within a period of time after meeting 100) computer system 120 is configured to delete the recording of the particular meeting 100.

Accordingly, the embodiments depicted in FIG. 1 enable various individuals 102 to engage in meetings 100 and record what was discussed at meeting 100. Further, in various embodiments depicted in FIG. 1, the various individuals 102 are able to retain a recording of the meeting 100 for subsequent playback after the meeting 100 has started including portions of the meeting 100 that occurred before the decision to record the meeting 100. Accordingly, in embodiments, individuals 102 may be able to retain a record of a meeting 100 even if none of the individuals 102 decided to record the meeting 100 from the outset. This may be advantageous, for example, when an important decision, discussion, or innovation occurs during a routine discussion (e.g., a weekly status meeting) that was not expected to be worth retaining for later playback. If, for example, individual 102X makes an important statement 106X during a presentation, key individual 102Z might state “That is a great idea! Were we recording that?”, the disclosed techniques allow the individuals 102 attending meeting 100 to retroactively decide to retain a recording of meeting 100 for subsequent playback such that individual 102X's important statement 106X is retained.

Referring now to FIG. 2, an expanded block diagram of the computer system 120 of FIG. 1 is depicted in accordance with various embodiments. In addition to controller module 122, scheduling module 124, communications module 126, and long-term storage 130 shown in FIG. 1, the computer system 120 depicted in FIG. 2 further includes a meeting module 200, an identification module 210, a security module 220, and short-term storage 230.

Controller module 122 causes computer system 120 to perform the operations discussed herein, including coordinating the operations performed with scheduling module 124, communications module 126, and long-term storage 130. For example, controller module 122 is configured to receive meeting information 110 and recording confirmation command 112 (with communications module 126) and retain the received meeting information 110 as recorded meeting 240 (in long-term storage 130). In various embodiments, controller module 122 also interfaces with short-term storage 230 and creates and maintains meeting metadata 250. In various embodiments, controller module 122 includes meeting module 200, identification module 210, and security module 220.

In various embodiments, meeting module 200 facilitates making determinations about meeting 100 and assembling meeting information 110 into a recorded meeting 240 as discussed herein. In various embodiments, meeting module 200 includes recording module 202. As discussed herein, in various embodiments, meeting module 200 records various determinations about meeting 100 as meeting metadata 250.

In various embodiments, meeting module 200 detects the start of meeting 100 and determines that meeting 100 has ended. In some of such embodiments, detecting the start of meeting 100 is based on receiving a meeting start command from one of the computing devices 108. Further, in some embodiments detecting the start of meeting 100 includes accessing the schedule (e.g., with scheduling module 124) to determine a location of a particular meeting 100 (or a plurality of locations for meetings 100 occurring in multiple places), the scheduled start time of the particular meeting 100, and the plurality of individuals 102 indicated as participating in the particular meeting 100. In such embodiments, meeting module 200 monitors one or more recording devices 104 associated with the location(s) beginning at a start time of meeting 100 to detect one or more voices of the plurality of individuals 102. As discussed herein, in some embodiments, identification module 210 is used to identify the particular individuals 102 whose voices are detected by the one or more recording device 104. However, in other embodiments, meeting module 200 merely detects sounds at the location(s) that are above a certain volume and similar to human voices (e.g., within the frequency range of human voices). In other embodiments, detecting the start of meeting 100 includes checking a schedule (e.g., with scheduling module 124) to identify the scheduled start time of a particular meeting 100 (e.g., 12:00 GMT) and the location(s) where the meeting is scheduled to occur, checking the current time, and determining that the scheduled start time is the current time.

Similarly, in some embodiments, determining that meeting 100 has ended is based on receiving a meeting stop command from one of the computing devices 108. Further, in some embodiments determining that meeting 100 has ended includes accessing the schedule (e.g., with scheduling module 124) to determine a location of a particular meeting 100 (or a plurality of locations for meetings 100 occurring in multiple places), the scheduled end time of meeting 100, and the plurality of individuals 102 indicated as participating in the particular meeting 100. In such embodiments, meeting module 200 monitors one or more recording devices 104 associated with the location(s) to determine that the voices of the plurality of individuals 102 are no longer detected detected. As discussed herein, in some embodiments, identification module 210 is used to identify the particular individuals 102 whose voices were previously detected by the one or more recording device 104, and meeting module 200 determines that the voices of the particular individuals 102 are no longer detected. However, in other embodiments, meeting module 200 merely determines that sounds similar to human voices (e.g., within the frequency range of human voices) above a certain volume are no longer detected. In other embodiments, determining that meeting 100 has ended includes checking a schedule (e.g., with scheduling module 124) to identify the scheduled end time of a particular meeting 100 (e.g., 12:00 GMT) and the location(s) where the meeting is scheduled to occur, checking the current time, and determining that the scheduled end time is the current time.

In various embodiments, meeting module 230 is configured to implement the “meeting software” used by some or all of the individuals 102 attending meeting 100. As used herein, “meeting software” refers to software running on a computer system (e.g., computer system 120) locally on a computing device 108 associated with an individual 102 and/or remotely on a server or group of servers that facilitates meeting 100 including identifying individuals 102 and allowing individuals 102 to exchange audio, video, and/or electronic message information between one another. For example, individual 102X may give a presentation by accessing meeting software and sharing their screen and individual 102Y and individual 102Z may attend the meeting and watch individual 102X's presentation using meeting software that receives the information individual 102X is sharing from their screen. In various embodiments, meeting module 230 runs the meeting software and remotely displays meeting information on computers associated with the various individuals 102. In various embodiments, the meeting software may include modules that implement portions of the tasks performed by recording device 104 discussed herein.

Identification module 210 is configured to determine the identities of the various individuals 102 attending meeting 100. In various embodiments, identification module 210 is configured to determine the identities of individuals 102 by one or more of requesting that the various individual 102 identify themselves, analyzing audio and recognizing the various voices of individuals 102, and analyzing video or images and recognizing the images of the face or other body parts of the individuals 102. In some of such embodiments, identification module 210 is configured to request that the various individual 102 identify themselves by requesting that the individuals 102 present a credential associated with themselves (e.g., user login and password, biometric identification, voiceprint identification) and/or a credential associated with a computing device 108 associated with individual 102 or another device associated with the individual 102 (e.g., a changing number generated by a security token device, a code or token stored on an identification badge). In various embodiments, identification module 210 requests that individuals 102 identify themselves before joining meeting 100 (e.g., by requiring individuals 102 to log in to meeting software before joining meeting 100, by requesting the individual 102 speak his or her name before joining meeting 100, by requiring a roll call of individuals 102 attending meeting 100 before meeting 100 begins).

In other embodiments, identification module 210 is configured to identify individuals 102 based on their voice and/or image. In embodiments where identification module 210 identifies individuals 102 by voice, identification module 210 may be configured to store voice prints 212 associated with the various individuals' 102 profiles such that when a voice of an individual 102 in meeting information 110 is compared to the individual's voice print 210, the identification module 210 is able to determine the individual's 102 identity. Similarly, in embodiments where identification module 210 identifies individuals 102 by image, identification module 210 may be configured to store one or more reference images 214 associated with the various individuals' 102 profiles such that when an image of an individual 102 in meeting information 110 is compared to the individual's reference image 214, the identification module 210 is able to determine the individual's 102 identity.

Security module 220 is configured to perform various security operations for computer system 120. In various embodiments, such security operations include but are not limited to decrypting received meeting information 110 and/or recording confirmation command 112 and encrypting stored recorded meetings 240 and/or meeting metadata 250. In various embodiments, security module 220 restricts access to recorded meetings 240, meeting metadata 250, and/or schedule to authorized entities using any of a number of security techniques including cryptography, storing restricted information on physically separate media, restricting a given entity's access to long-term storage 130 or short-term storage 230 to certain memory locations associated with that given entity, or a combination. Accordingly, in some embodiments in which the schedule includes information indicating that a first plurality of meetings 100 that are associated with a first entity are scheduled to occur, and information indicating that a second plurality of meetings that are associated with a second entity are scheduled to occur, the security module 220 restricts access by the first entity to recorded meetings 240 and meeting metadata 250 associated with the first entity and prevents the second entity from accessing the recorded meetings 240 and meeting metadata 250 associated with the first entity. Likewise, security module 220 restricts access by the second entity to recorded meetings 240 and meeting metadata 250 associated with the second entity and prevents the first entity from accessing the recorded meetings 240 and meeting metadata 250 associated with the second entity. This may be accomplished, for example, by encrypting the recorded meetings 240 and meeting metadata 250 associated with the first entity such that only the first entity has the ability to decrypt the recorded meetings 240 and meeting metadata 250 associated with it.

Scheduling module 124 access a schedule that includes information about one or more meetings 100. In various embodiments, the schedule includes information indicating a plurality of meetings that are scheduled to occur. In some of such embodiments, the schedule includes additional information about meetings 100 that are scheduled to occur including but not limited to the scheduled start time of the meetings 100, the scheduled end time of the meetings 100, the location(s) of the meetings 100, the individuals 102 who have been invited to the meetings 100, whether the presence of certain individuals 102 is required, the individuals 102 who have indicated they will attend the meetings 100, the individuals 102 who have indicated they will not attend the meetings 100, contact information for the individuals 102 have who been invited to the meetings 100, and one or more hyperlinks that are usable to access meeting software associated with the meetings 100. In various embodiments, the schedule includes information about meetings 100 that are associated with more than one entity (e.g., more than one enterprise, more than one division within a single enterprise), and in such embodiments the schedule includes information indicating that a first plurality of meetings 100 are associated with a first entity, that a second plurality of meetings 100 are associated with a second entity, etc.

Communications module 126 receives messages sent to computer system 120 and sends messages from computer system 120 to facilitate communication. Communications module 126 is configured to receive meeting information 110, receive recording confirmation command 112, send challenge message 332, receive response to challenge message 334, and provide access to recorded meetings 240. Communications module 126 may include any of a number of wired (e.g., ethernet, USB, etc.) or wireless (e.g., cellular radio, WiFi) communications devices and protocols. In various embodiments, computer system 120 sends and receives communication from local area networks and wide area networks (e.g., the Internet). In various embodiments, communications module 126 is configured to receive input from recording devices 104. In such embodiments, communications module 126 may include one or more audio jacks and/or one or more video jacks. Such audio and/or video jacks may be analog (e.g., a headphone jack) or digital (e.g., an HDMI port). In various embodiments, communications module 126 is configured to receive messages from computer systems associated with various individuals 102 communicating with computer system 120 over a network. For example, communications module 126 may receive messages from meeting software during the meeting including audio information or visual information generated by one or more individuals 102 during meeting 100.

Long-term storage 130 is usable to store program instructions executable by computer system 120 to perform various operations described herein as well as recorded meetings 230 and meeting metadata 250. Short-term storage 230 is usable to store recorded meetings 230 and meeting metadata 250 (not shown). Long-term storage 130 and short-term storage 230 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. As used herein, “long-term storage” and “short-term storage” are relative terms used to refer to the amount of time information is retained in each. For example, in various embodiments information in long-term storage is retained for a long period of time (e.g., years), and information in short-term storage is retained for a shorter duration (e.g., hours, days, weeks, months) before being deleted. In various embodiments, information in long-term storage is stored for an indefinite period of time (i.e., when the information is stored in long-term storage, the date for its eventual deletion is not predetermined) and information in short-term storage is stored for a predetermined period of time (e.g., information in short-term storage is deleted after two weeks, one month, two months, etc.).

In various embodiments, short-term storage 230 is implemented using a temporary buffer. In such embodiments, prior to receiving recording confirmation command 112 associated with a particular meeting, the recorded meeting 240 for the particular meeting 100 is stored in the temporary buffer. In such embodiments, causing the recorded meeting 240 for the particular meeting 100 to be retained (i.e., in long-term storage 130) includes storing, in a file to be retained for subsequent playback, portions of the particular meeting 100 occurring from the time of the recording confirmation command 112 was received to an end of the particular meeting 100; and causing contents of the temporary buffer to be associated with the file. In some of such embodiments, the temporary buffer has a maximum size and is configured to discard portions of the recorded meeting 240 for the particular meeting 100 when the amount stored in the temporary buffer exceeds the maximum size. Accordingly, in some embodiments, at the time that recording confirmation command 112 is received, a portion of the recorded meeting 240 for the particular meeting 100 has been discarded from the temporary buffer. The maximum size of the temporary buffer may be a particular period of time (e.g., 15 minutes, 30 minutes) or a particular amount of memory (e.g., a 1 gigabyte). The maximum size of the temporary buffer may be dependent in part on the specifications of computer system 120 (e.g., the amount of available memory in short-term storage 230). In other embodiments, the maximum size of the temporary buffer may be dependent in part on a license purchased by the enterprise with which meeting 100 is associated. Thus, for example, a standard licensee enterprise may have a smaller maximum size (e.g., 30 minutes), a premium licensee enterprise may have a larger maximum size (e.g., 60 minutes), and super premium licensee may have an unlimited maximum size.

The recorded meetings 240 stored in long-term storage 130 are retained for subsequent playback. Computer system 120 may make the recorded meetings 240 available for playback in any of a number of ways. For example, communications module 126 may stream the recorded meetings 240 to users (e.g., individuals 102) via a graphical user interface. Additionally, communications module 126 may send a complete copy of recorded meeting 240 to a computing device 108.

Recorded meetings 240 includes meeting information 110 that has been captured (e.g., by recording devices 104) for a given meeting 100 and received by computer system 120. A given recorded meeting 240 may include audio information (e.g., vocally-spoken statements 106 from individuals 102), visual information (e.g., images, video, electronic messages, presentations given at meeting 100, display information from at least one of the computing devices 108 associated with ones of the plurality of individuals 102 attending meeting 100), information indicative of accesses and/or revisions to one of more files made by one of more of the individuals 102 using one of more computing device 108 during meeting 100, or a combination. Recorded meetings 240 may be stored in short-term storage 230, where they will eventually be deleted according to a data retention policy as discussed herein. Recorded meetings 240 may be stored in long-term storage 130, where they are retained for subsequent playback as discussed herein.

In various embodiments, recorded meeting 240 includes several streams of information synched together. Recorded meeting 240 may include a timeline that may be used to correlate various information recorded by recording devices 104 together. Thus, in various embodiments, visual (e.g., recorded with a camera, recorded with a computer screen recorder) information is synced to the audio (e.g., recorded with a microphone) information such that a video of an individual 102 speaking is synced to the audible sounds of the individual's 102 voice) and/or a video of the information an individual 102 shared using his or her computer is synced to audio of the individual 102 speaking about the shared information. In embodiments, multiple sources of audio and/or video may be mixed together in recorded meeting 240. In some embodiments, for example, the audio from individual 102X may be recorded with a first recording device 104 (e.g. a microphone worn by individual 102X) and individuals 102Y and 102Z may be recorded with a second recording device 104 (e.g., a microphone on the table). These different audio sources may be mixed together into a single audio track, or they may be kept on separate tracks and synced up when the recorded meeting 240 is played back. Additionally, recorded meeting 240 may include visual information from multiple camera angles recorded in separate video feeds that may be played back separately or simultaneously. Electronic information such as visual signals showing information an individual 102 is sharing from a computer or a record of chat information may also be recorded separately synced to the other audio and/or visual information in recorded meeting 240.

Meeting metadata 250 includes information about the various recorded meetings 230. In various embodiments, meeting metadata 250 includes, for a given meeting 100, the start time of the meeting 100, the end time of the meeting 100, the duration of the meeting 100, the location of the meeting 100, indications of the plurality of individuals (e.g., names, titles, position, etc.), an indication of the recording confirmation command(s) 112 received for the meeting, or a combination. The indication of the recording confirmation command(s) 112 may include when the recording confirmation command 112 was received, the individual 102 (or individuals 102) whose assent was indicated by the recording confirmation command 112, and the manner in which the recording confirmation command 112 was received (e.g., via a spoken command, via a graphical user interface, etc.), or a combination.

In various embodiments, a blockchain-based shared ledger is used to store meeting metadata 250 and coordinate the various recorded meetings 240 stored in long-term storage 130. In these embodiments, a copy of the shared ledger is stored on computer system 120 as well as the computer systems (e.g., computing devices 108) used to access recorded meetings 240. In such embodiments, the shared ledger is used to facilitate and restrict accesses to the various recorded meetings 240. In such embodiments, access to a given stored recorded meeting 240 is conditioned on whether a recording confirmation command 112 has been received for the given recorded meeting 240. Because computer system 120, the computer system (e.g., a computing device 108) being used by an individual attempting to access a given recorded meeting 240, and computer systems (e.g., computing devices 108) associated with other individuals all have copies of the same shared ledger, the shared ledger may provide additional assurance that users are not given access to a given recorded meeting 240 for which a recording confirmation command 112 has not been received. For example, if an individual attempting to access a given recorded meeting 240 has fraudulently modified his or her copy of the shared ledger to indicate that a recording confirmation comment 112 has been received for the given recorded meeting 240 in order to gain access, the shared ledger on computer system 120 and the other user's computing systems would be usable to identify the fraudulent change and the computer system 120 could deny access to the given recorded meeting 240.

In various embodiments, for each given recorded meeting 240, the shared ledger includes meeting metadata 250 indicative of the individuals 100 who attended the given meeting 100, and information indicative of whether ones of the individuals 102 who attended the given meeting 100 have assented to access to the given recorded meeting 240 (e.g., via a recording confirmation command 112). When an additional meeting 100 is recorded as discussed herein, computer system 120 adds to the shared ledger metadata 250 indicative of the plurality of individuals 102 who attended the additional meeting 100, and information indicative of ones of the plurality of individuals 102 that have assented to access to the recorded meeting 240. Later, when a user seeks to access the additional recorded meeting 240, computer system 120 determines, based on the shared ledger, whether to grant access to the recorded meeting 240.

Further, the shared ledger may also be used to determine whether to accept a proposed change to a recorded meeting 240. Such a proposed change may include removing portions of a recorded meeting 240 (e.g., removing audio and/or visual information associated with an individual 102 making rude, abusive or offensive statements, removing audio tracks with loud background noise, and removing audio and/or visual information with poor quality (e.g., a low bitrate, poor connection during meeting 100, etc.)) or adding a portion to recorded meeting 240 (e.g., by adding visual information corresponding to a slide presentation given at meeting 100). Individuals 102 who attend the meeting 100 for which a change has been proposed may indicate their assent (or not) to the change, and such assent (or not) may be noted in the shared ledger. If the shared ledger indicates sufficient assent to the change (e.g., majority rules, unanimous assent, etc.), computer system 120 makes the change to recorded meeting 240.

A computer system 120, as shown in FIG. 2, may therefore be used to receive meeting information 110 and recording confirmation commands 112 associated with meeting 100, and store a recorded meeting 240 based on the received meeting information 110. If a recording confirmation command 112 has been received for a particular meeting 100, a recorded meeting 240 for the particular meeting 100 is retained in long-term storage 130 for subsequent playback. If a recording confirmation command 112 has not been received, in various embodiments, computer system 120 will not save recorded meeting 240 in long-term storage 130 and any portions of recorded meeting 240 stored in short-term storage 230 will be deleted according to a data retention policy. During operation, computer system 120 receives the recording confirmation command 112 during meeting 100 in some instances, but in other instances computer system 120 receives the recording confirmation command 112 after meeting 100 has ended. Accordingly, computer system 120 provides the advantageous ability to retroactively decide to record a meeting 100 in the middle of the meeting 100, or a period of time after the meeting 100 has concluded.

Referring now to FIGS. 3A, 3B, 3C. and 3D, various timelines illustrating the chronology of key events in accordance with the disclosed embodiments are shown. Each of FIGS. 3A, 3B, 3C, and 3D include a start point 302 indicating the start of meeting 100 and an end point 306 indicating the end of meeting 100. As discussed herein, meeting information 110 pertaining to meeting 100 is captured and sent to computer system 100 between start point 302 and end point 306. FIG. 3A shows a timeline 300 in which a recording confirmation command 112 is received from one or more individuals 102 attending meeting 100 before end point 306. Thus timeline 300 includes embodiments in which recording confirmation command is received during meeting 100 and while meeting 100 is being recorded. In various embodiments where recorded meeting 240 is stored in short-term storage 230 with a limited size, recorded portions of meeting 100 are discarded if the size (or length) of recorded meeting 240 exceeds the maximum size. In such embodiments, the starting point of the recorded meeting 240 retained in long-term storage 130 for subsequent playback is indicated by point 304. Accordingly, in the disclosed embodiment the recorded meeting 240 retained in long-term storage 130 does not include portions of meeting 100 that occurred between start point 302 and point 304.

In various embodiments, recording confirmation command 112 is sent by (or on the behalf of) particular individual(s) 102 indicating that the particular individual(s) 102 assents to retaining the recorded meeting 240. Recording confirmation command 112 may be communicated to computer system 120 in any of a number of ways. In some embodiments, recording confirmation command 112 is a direct verbal command to record meeting 100 (e.g., “Start recording of meeting”) given by an individual 102 and received via a recording device 104. In other embodiments, recording confirmation command 112 is not a direct command but is intuited by computer system 120 based on words spoken by individuals 102. For example, individual 102X may make an important statement and individual 102Y may say something like “Are we recording this?” or “Is this meeting being recorded?”, and computer system 120 interprets individual 102Y's statement as a command to retain the recorded meeting 240 for subsequent playback. In other embodiment, recording confirmation command 112 is a gesture given by an individual 102 (e.g., waving a hand back and forth three times). In still other embodiments, recording confirmation command 112 is an electronic command received via a graphical user interface (e.g., a graphical user interface of meeting software). In some embodiments, only certain individuals 102 are empowered to give recording confirmation command 112. For example, in some embodiments, only the individual 102 who organized meeting 100 is empowered to give recording confirmation command 112. In other embodiments, only a high-ranking individual 102 (e.g., key individual 102Z) is empowered to give recording confirmation command 112.

Referring now to FIG. 3B, a timeline 310 is shown. In timeline 310, recording confirmation command 112 is received from one or more individuals 102 attending meeting 100 after end point 306. Additionally, timeline 310 does not include a point 304. Accordingly, timeline 310 shows an embodiment where recording confirmation command 112 was received after the end of meeting 100 and in which the recorded meeting 240 associated with meeting 100 includes all of the meeting information 110 received by computing system 120 for meeting 100.

Referring now to FIG. 3C, a timeline 320 is shown. In timeline 320, no recording confirmation command 112 has been received for a particular meeting 100. At point 322 occurring an amount of time after end point 306, the expiration of the hold period occurs. As discussed herein, in various embodiments, computer system 120 is configured to retain, for an amount of time, recorded meetings 240 for which a recording confirmation command 112 has not been received (e.g., in short-term storage 230). In various embodiments, this hold period (i.e., the period of time after the end of meeting 100 that recorded meeting 240 is retained), is a set amount of time (e.g., 2 weeks, 1 month, 3 months, 6 months, etc.). In other embodiments, this hold period is dictated by available memory on computer system 120 (e.g., older recorded meetings 240 may be deleted to make room for newer recorded meetings 240). In various embodiments, the duration of the hold period is dependent in part on a license purchased by the enterprise with which meeting 100 is associated. For example, in such embodiments, the hold period for licensees who have purchased the “premium” license is longer than the hold period for licensees who have purchased the “standard” license. Having received no recording confirmation command 112 and after the expiration of the hold period, the recorded meeting 240 for the particular meeting 100 is deleted at point 324.

Referring now to FIG. 3D, a timeline 330 is shown. In timeline 330 (as in timeline 300), the recording confirmation command 112 is received before end point 306 (i.e., during meeting 100). The embodiment depicted in timeline 330, however, differs from timeline 300 in that after recording confirmation command 112 from one or more individuals 102 is received, in response to receiving recording confirmation command 112 computer system 120 issues a challenge message 332, and the one or more individuals 102 provide a response to challenge message 334. The computer system 120 then retains the recorded meeting 240 of the particular meeting 100 based on the response to challenge message 334. In various embodiments, challenge message 332 asks the individuals 102 attending meeting 100 how much of meeting 100 before the recording confirmation command 112 was received computer system 120 should retain for subsequent playback. In some embodiments, based on a response to challenge message 334 indicating that all of the meeting 100 should be retained for playback, computer system 120 retains all portions of meeting 100 occurring between start point 302 and end point 306 as recorded meeting 240. In other embodiments, based on a response to challenge message 334 indicating that only a portion of meeting 100 should be retained for playback, computer system 120 portions of meeting 100 occurring between point 304 and end point 306 as recorded meeting 240.

Challenge message 332 may be issued in any of a number of ways including but not limited to a pop-up on meeting software facilitating meeting 100, an audio message played during meeting 100 (e.g., via a speaker coupled to recording device 104 or a computing device 108), an email, or a message sent to one or more computing device 108. As discussed above, challenge message 332 may inquire as to how much of meeting 100 should be retained for subsequent playback. Additionally or alternatively, challenge message 332 may ask that individuals 102 other than the individual(s) 102 who sent the recording confirmation command 112 also assent to retaining a recorded meeting 240 for meeting 100 (e.g., asking for the assent of a majority of individuals 102, asking for the unanimous assent from all individuals 102). Challenge message 332 may also ask what kind of meeting information 110 should be retained for future playback (e.g., audio only, video and audio, audio and information indicating files access or modified during meeting 100). Challenge message 332 may also ask whether access to the recorded meeting 240 should be restricted (e.g., to only the individuals 102 attending meeting 100, only to users with a high enough security clearance level, etc.). Further, in embodiments where recording confirmation command 112 is not a direct command but is intuited by computer system 120 based on words spoken by individuals 102, challenge message 332 may confirm whether the individuals 102 would like to record meeting 100 (e.g., in response to individual 102Y stating “Are we recording this?”, challenge message 332 may be an audio message “Would you like to start recording this meeting?”).

Response to challenge message 334 may similarly given in any of a number of ways including but not limited to interaction with a graphical user interface on meeting software facilitating meeting 100, spoken responses by individuals 102, gestures given by individuals 102, an email, or a message sent with one or more computing devices 108. Response to challenge message 334 may include any of a number of commands in response to challenge message 332 as well as unsolicited commands (e.g., a command to retain only a portion of meeting 100, a command to restrict access to recorded meeting 240, etc.).

Accordingly, in various embodiments recording confirmation command 112 is received during meeting 100. In other embodiments, recording confirmation command 112 is received after meeting 100. In embodiments, all of the meeting 100 from start point 302 and end point 306 is retained for future playback. In other embodiments, only portions of the meeting 100 are retained for future playback. Further, in embodiments where a recording confirmation command 112 is not received within a period of time, recorded meeting 240 is deleted.

FIGS. 4 and 5 illustrate various flowcharts representing various disclosed methods implemented with computer system 120. Referring now to FIG. 4, a flowchart illustrating an embodiment of a meeting recording method 400 is shown. In various embodiments, the various actions associated with method 400 are performed with computer system 120. At block 402, computer system 120 accesses a schedule including information indicating a plurality of meetings 100 that are scheduled to occur. At block 404, computer system 120 detects, using the schedule, a start of a particular meeting 100 between a plurality of individuals 102. At block 406, computer system 120, initiates, based on the detecting, a recording (e.g., recorded meeting 240) of the particular meeting 100, wherein the recording includes audio of the particular meeting 100. At block 408, computer system 120, while the particular meeting 100 is being recorded, receives from the plurality of individuals 102, a recording confirmation command 112. At block 410, computer system 120, after determining that the particular meeting has ended and based on having received the recording confirmation command, causes the recording of the particular meeting 100 to be retained by the computer system 120 for subsequent playback.

For example, individuals 102X, 102Y, and 102Z schedule a meeting 100 to occur at a particular time. For this meeting 100, each of individuals 102X, 102Y, and 102Z will attend in person at the same location (e.g., Meeting Room 1). An individual 102 (or a person assisting an individual 102) enters information about the meeting (e.g., invited individuals 102, location(s) of meeting, start time, end time) into a schedule (e.g., with meeting software) maintained by scheduling module 124. Individuals 102 are affiliated with an entity, Meeting Corp., that has numerous meetings scheduled at various times and in various locations. Scheduling module 124 accesses the schedule and determines that meeting 100 between individuals 102X, 102Y, and 102Z has begun (e.g., by determining that meeting 100 was scheduled to start at the current time, by detecting voices at with a recording device 104 in Meeting Room 1, etc.). As the meeting 100 is in progress, computer system 120 initiates a recording (e.g., with recording module 202) of the meeting, and receives meeting information 110 from at least one recording device 104 in Meeting Room 1. As discussed herein, prior to receiving a recording confirmation command 112, computer system 120 may store the recorded meeting 240 in short-term storage 230. While the meeting 100 is being recorded, the computer system 120 receives a recording confirmation command 112 from individual 102X (e.g., via a verbal command, via a command entered into a graphical user interface in meeting software running on a computing device 108, etc.). The meeting 100 continues until the individuals 102 end the meeting. As discussed herein, computer system 120 determines that the meeting 100 has ended (e.g., none of the voices of individuals 102X, 102Y, and 102Z are detected at Meeting Room 1 anymore). Having determined that the meeting 100 has ended and having received a recording confirmation command 112, computer system 120 causes the recording of the particular meeting 100 to be retained by the computer system 120 (e.g., in long-term storage 130) for subsequent playback.

Referring now to FIG. 5, a flowchart illustrating an alternative embodiment of a meeting recording method 500 is shown. In various embodiments, computer system 120 executes computer-readable instructions that when executed cause computer system 120 to perform the various operations associated with method 500. At block 502, computer system 120 stores a plurality of recordings of meetings 100 between individuals 102 (e.g., recorded meetings 240). At block 504, computer system 120 maintains a blockchain-based shared ledger associated with the plurality of recordings (e.g., recorded meeting 240). In embodiments, the shared ledger stores metadata 250 associated with the plurality of recordings including for a given recording of a given meeting 100, metadata 250 indicative of the individuals 102 who attended the given meeting 100, and information indicative of whether ones of the individuals 102 who attended the given meeting 100 have assented to access to the given recorded meeting 240. At block 506, computer system 120 initiates a first recording of a first meeting 100 between a first plurality of individuals 102, wherein the recording includes recorded audio of the first meeting 100. At block 508, computer system 120 stores the first recording at the computer system 120. At block 510, computer system 120 adds metadata 250 indicative of the first plurality of individuals 102 who attended the first meeting 100 to the shared ledger. At block 512, computer system 120 receives first information (e.g., recording confirmation command 112) indicative of ones of the first plurality of individuals 102 that have assented to access to the first recording. At block 514, computer system 120 adds metadata 250 indicative of the first information to the shared ledger. At block 516, computer system 120 determines, based on the shared ledger, whether to grant access to the first recording.

For example, individuals 102 associated with Meeting Corp. routinely engage in meetings 100, resulting in a plurality of recorded meetings 240. A computer system 120 stores this plurality of recorded meetings 240 associated with Meeting Corp. Computer system 120 also maintains a blockchain-based shared ledger associated with recorded meetings 240. The shared ledger stores metadata 250 associated with the recorded meetings 240. In this embodiment, the shared ledger stores information indicative of the individuals 102 who attended each recorded meeting 240 (e.g., names, employee numbers) and information indicative of whether the individuals 102 who attended each meeting 100 have assented to access to the particular recorded meeting 240 (e.g., whether individual 102X who attended Meeting X on Mar. 10, 2018 has assented to access to the recording of Meeting 123). Computer system 120 initiates a recording (e.g., with recording module 202) of a meeting 100 (e.g., Meeting Y) between a plurality of individuals 102X, 102Y, and 102Z including audio of the meeting 100. Computer system 120 stores the recording (e.g., a recorded meeting 240) of Meeting Y. Computer system 120 also adds metadata 250 indicative of the fact that individuals 102X, 102Y, and 102Z attended Meeting Y to the shared ledger. Computer system 120 receives a recording confirmation command 112 from individual 102X which indicates individual 102X's assent to access of the recording of Meeting Y, and computer system 120 adds metadata 120 indicative of individual 102X's assent to the shared ledger. Then, based on the shared ledger, computer system 120 determines whether to give access to the recording of Meeting Y. For example, in embodiments where assent from only one individual 102 is necessary to permit access to recorded meeting 240, access to Meeting Y is granted because the shared ledger indicates that individual 102X has assented. However, in embodiments where assent from a majority of all individuals 102 is necessary to permit access to a recorded meeting 240, access to the recording of Meeting Y will not be granted because individuals 102Y and/or 102Z have not indicated their assent to access.

### Exemplary Computer System

Turning now to FIG. 6, a block diagram of an exemplary computer system 600, which may implement the various components of computer system 120, is depicted. Computer system 600 includes a processor subsystem 660 that is coupled to a system memory 620 and I/O interfaces(s) 640 via an interconnect 660 (e.g., a system bus). I/O interface(s) 640 is coupled to one or more I/O devices 650. Computer system 600 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 600 is shown in FIG. 6 for convenience, system 600 may also be implemented as two or more computer systems operating together.

Processor subsystem 660 may include one or more processors or processing units. In various embodiments of computer system 600, multiple instances of processor subsystem 660 may be coupled to interconnect 660. In various embodiments, processor subsystem 660 (or each processor unit within 660) may contain a cache or other form of on-board memory.

System memory 620 is usable to store program instructions executable by processor subsystem 660 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 660 and secondary storage on I/O Devices 650 (e.g., a hard drive, storage array, etc.). In some embodiments, these other forms of storage may also store program instructions executable by processor subsystem 660.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
accessing, by a computer system, a schedule including information indicating a plurality of meetings that are scheduled to occur;
detecting, by the computer system using the schedule, a start of a particular meeting between a plurality of individuals;
initiating, by the computer system based on the detecting, a recording of the particular meeting, wherein the recording includes audio of the particular meeting;
while the particular meeting is being recorded, receiving, at the computer system from one of the plurality of individuals, a recording confirmation command; and
after determining that the particular meeting has ended and based on having received the recording confirmation command, causing, by the computer system, the recording of the particular meeting to be retained by the computer system for subsequent playback.

2. The method of claim 1,
wherein detecting the start of the particular meeting includes:
accessing the schedule to determine a location of the particular meeting and the plurality of individuals indicated as participating in the particular meeting; and
monitoring one or more recording devices associated with the location beginning at a start time of the particular meeting to detect one or more voices of the plurality of individuals.

3. The method of claim 1, wherein the schedule includes information indicating:
that a first plurality of meetings that are associated with a first entity are scheduled to occur; and
that ones of the first plurality of meetings are scheduled to occur at one or more locations.

4. The method of claim 1,
wherein the schedule includes information indicating:
that a first plurality of meetings that are associated with a first entity are scheduled to occur, wherein the first plurality of meetings includes the particular meeting; and
that a second plurality of meetings that are associated with a second entity are scheduled to occur; and
wherein the recording of the particular meeting is retained by the computer system for subsequent playback to the first entity and not the second entity.

5. The method of claim 1, wherein the recording confirmation command is an electronic command received via a graphical user interface.

6. The method of claim 1, wherein the recording confirmation command is a verbal command received via one or more recording devices associated with the particular meeting.

7. The method of claim 1, further comprising:
prompting, by the computer system and in response to receiving the recording confirmation command, one of the plurality of individuals with a challenge message; and
while the particular meeting is being recorded, receiving, at the computer system from ones of the plurality of individuals, one or more responses to the challenge message;
wherein causing, by the computer system, the recording of the particular meeting to be retained by the computer system for subsequent playback is based on the one or more responses to the challenge message.

8. The method of claim 1, wherein determining that the particular meeting has ended includes receiving a meeting stop command from one or more of the plurality of individuals, a lack of detecting voices of any of the plurality of individuals over a threshold amount of time, or both.

9. The method of claim 1,
wherein prior to receiving a recording confirmation command, the recording of the particular meeting is stored in a temporary buffer and
wherein causing the recording of the particular meeting to be retained includes:
storing, in a file to be retained for subsequent playback, portions of the particular meeting occurring from the time of the recording confirmation command was received to an end of the particular meeting; and
causing contents of the temporary buffer to be associated with the file.

10. The method of claim 9, wherein the temporary buffer has a maximum size and wherein, at a time that the recording confirmation command is received, a portion of the recording of the particular meeting has been discarded from the temporary buffer.

11. The method of claim 1, further comprising:
storing, by the computer system in a blockchain-based shared ledger, metadata indicative of:
the recording of the particular meeting,
the plurality of individuals, and
the recording confirmation command.

12. A non-transitory, computer-readable medium storing instructions that when executed by a computer system cause the computer system to perform operations comprising:
accessing a schedule including information indicating that a plurality of meetings that are scheduled to occur;
detecting, using the schedule, a start of a particular meeting between a plurality of individuals;
initiating, based on the detecting, a recording of the particular meeting, wherein the recording includes audio of the particular meeting;
determining whether a recording confirmation command was received from one of the plurality of individuals during the particular meeting; and
after determining that the particular meeting has ended:
in response to determining that the recording confirmation command was received during the meeting, causing the recording of the particular meeting to be retained by the computer system for subsequent playback; or
in response to determining that the recording confirmation command was not received during the meeting, deleting the recording of the particular meeting.

13. The non-transitory, computer-readable medium of claim 12, wherein the operations further comprise:
communicating with one or more computing devices associated with ones of the plurality of individuals;
wherein the recording includes display information from at least one of the computing devices associated with ones of the plurality of individuals.

14. The non-transitory, computer-readable medium of claim 12, wherein the operations further comprise:
communicating with one or more computing devices associated with ones of the plurality of individuals;
wherein the recording includes information indicative of accesses, revisions, or both of one or more electronic files.

15. The non-transitory, computer-readable medium of claim 12, wherein the operations further comprise:
communicating with one or more computing devices associated with ones of the plurality of individuals;
wherein detecting the start of the meeting is based on receiving a meeting start command from one of the computing devices.

16. The non-transitory, computer-readable medium of claim 12, wherein the operations further comprise:
communicating with one or more computing devices associated with ones of the plurality of individuals;
wherein determining that the particular meeting has ended includes receiving a meeting stop command from one of the computing devices.

17. A method comprising:
storing, at a computer system, a plurality of recordings of meetings between individuals;
maintaining, by the computer system, a blockchain-based shared ledger associated with the plurality of recordings, wherein the shared ledger stores metadata associated with the plurality of recordings including:
for a given recording of a given meeting, metadata indicative of the individuals who attended the given meeting, and
information indicative of whether ones of the individuals who attended the given meeting have assented to access to the given recording;
initiating, with the computer system, a first recording of a first meeting between a first plurality of individuals, wherein the first recording includes recorded audio of the first meeting;
storing the first recording at the computer system;
adding metadata indicative of the first plurality of individuals who attended the first meeting to the shared ledger;
receiving, at the computer system, first information indicative of ones of the first plurality of individuals that have assented to access to the first recording;
adding metadata indicative of the first information to the shared ledger; and
determining, based on the shared ledger, whether to grant access to the first recording.

18. The method of claim 17, further comprising:
receiving, at the computer system, a proposed change to the first recording;
receiving, at the computer system, second information indicative of ones of the first plurality of individuals that have assented to the proposed change to the first recording;
adding metadata indicative of the second information to the shared ledger; and
determining, based on the shared ledger, whether to accept the proposed change to the first recording.

19. The method of claim 17, wherein receiving the first information includes receiving the first information during the first meeting.

20. The method of claim 17, wherein receiving the first information includes receiving the first information after the first meeting has ended.
